(19) United States
(12) Patent Application Publication
(10) Pub. No.: US 2017/0032868 A1
(43) Pub. Date: Feb. 2, 2017

(54) INSULATED WIRE AND METHOD OF MANUFACTURING THE SAME

(71) Applicant: HITACHI METALS, LTD., Tokyo (JP)

(72) Inventors: Shigehiro Morishita, Tokyo (JP); Hideto Momose, Tokyo (JP); Takami Ushiwata, Tokyo (JP); Tsuyoshi Miura, Tokyo (JP)

(21) Appl. No.: 15/220,202

(22) Filed: Jul. 26, 2016

(30) Foreign Application Priority Data
Jul. 28, 2015 (JP) 2015-148319

(51) Int. Cl. H01B 3/30; H01B 13/14; H01B 3/28

(52) U.S. Cl. CPC H01B 3/308; H01B 3/28; H01B 13/145

(57) ABSTRACT

There is provided an insulated wire, comprising: a conductor; and an insulated layer arranged on an outer circumference of the conductor, wherein the insulate layer is made of a resin composition including polyphenylene sulfide resin and silicone rubber, and in a state of 160° C. or more, a mass loss of the insulated layer which is caused by generation of a siloxane gas from the silicone rubber, is less than 1% of the mass of the silicone rubber.

### BACKGROUND

### Technical Field

The present application is based on Japanese Applications No. 2015-148319 filed on Jul. 28, 2015, the entire contents of which are hereby incorporated by reference.

The present invention relates to an insulated wire, and a method of manufacturing the same.

Generally, the insulated wire includes a conductor and an insulated layer coating an outer circumference of the conductor. The insulated wire is wound and processed into a coil, and for example, is incorporated into electrical appliances such as rotating electric machines (motors) and transformers, etc.

In recent years, from a viewpoint of a miniaturization, the coil is processed by winding it around a small core with high tension and high density. Thus, processing stress added on the insulated wire is likely to be great. Therefore, the insulated wire is required to have a high adhesion with conductors so as not to be peeled-off (so-called a coat lifting) from the conductors or so as not to be cracked during coil processing.

Further, since the electrical appliances are driven at a high current for high output, an operating temperature of the coil is likely to be higher than before. Therefore, the insulated wire is also required to have a high heat resistance.

Further, since the electrical appliances are inverter-controlled for high efficiency, higher voltage such as inverter surge is easily applied to the coil. As a result, there is a high risk of allowing a partial discharge to occur in the vicinity of the insulated layer. The insulated layer is deteriorated when the partial discharge occurs, and therefore the insulated layer is required to have high partial discharge starting voltage and excellent electrical properties so as not to allow the partial discharge to occur at a low voltage.

As a resin for forming such an insulated layer, super engineering plastics are considered, and above all, there is a high attention to polyphenylene sulfide resin (also referred to as PPS resin hereafter), due to high heat resistance and high mechanical properties and excellent electrical properties (for example, see patent document 1). Generally, when the PPS resin is used as a material for forming the insulated layer because it has high crystallinity and because it is difficult to obtain a high adhesion to the conductors, it is used by mixing elastomer to obtain high adhesion (for example, see patent document 2).
Patent document 1: Patent Publication No. 4177295
Patent document 2: International Patent Publication No/2005/106898

### SUMMARY OF THE INVENTION

However, when the insulated layer is formed by a mixture of the PPS resin and elastomer, the heat resistance of the insulated layer is impaired due to elastomer, and therefore it is difficult to obtain a good balanced heat resistance, electrical properties, and adhesion to the conductors at a high level.

In view of the above-described problem, the present invention is provided, and an object of the present invention is to provide an insulated wire having excellent heat resistance, electrical properties, and adhesion to conductors.

According to an aspect of the present invention, there is provided an insulated wire, including:

a conductor; and

an insulated layer arranged on an outer circumference of the conductor,

wherein the insulate layer is made of a resin composition including polyphenylene sulfide resin and silicone rubber, and a mass loss of the insulated layer which is caused by generation of a siloxane gas from the silicone rubber, is less than 1% of the mass of the silicone rubber.

According to another aspect of the present invention, there is provided an insulated wire, including:

a conductor; and

an insulated layer arranged on an outer circumference of the conductor,

wherein the insulate layer is made of a resin composition including a silicone rubber polyphenylene sulfide resin and silicone rubber, and

a mass loss of the insulated layer caused by generation of a siloxane gas derived from the silicone rubber is less than 1% of the mass of the silicone rubber before and after heating of the insulated layer, when a temperature of the insulated layer is raised to 160° C. or more to heat it until the mass loss is saturated which is caused by generation of the siloxane gas derived from the silicone rubber.

According to further another aspect of the present invention, there is provided a method of manufacturing an insulated wire, including:

annealing a silicone rubber by raising a temperature of the silicon rubber to 160° C. or more and continuing the heating until a mass loss of the silicone rubber before and after heating, which is caused by generation of a siloxane gas, is less than 1% of the mass of the silicone rubber before heating;

preparing a resin composition by mixing the annealed silicone rubber and polyphenylene sulfide resin;

heating and melting the resin composition and extruding it so as to coat an outer circumference of a conductor; and

cooling the extruded resin composition to form an insulated layer.

### BRIEF DESCRIPTION OF THE DRAWINGS

FIG. 1 is a schematic view illustrating a constitution of an insulated wire according to an embodiment of the present invention.

In order to solve the above-described problem, inventors of the present invention study on a component which is elastomer capable of improving adhesion to a conductor of polyphenylene sulfide resin (PPS resin), and not impairing a heat resistance of an insulated layer when it is mixed into the PPS resin. As a result, it is confirmed that silicone rubber is suitable, and according to the silicon rubber, high adhesion can be secured without reducing the heat resistance of the insulated layer.

However, it is also found that when the silicone rubber is mixed, there is another problem that electrical properties of the insulated layer is reduced. Specifically, the insulated layer into which the silicone rubber is mixed, has a low dielectric constant and a high partial discharge starting voltage in a low temperature environment (for example 20° C.), and therefore the electrical properties are excellent. However, the dielectric constant becomes high as an environment temperature becomes high, and for example in a high temperature environment of 200° C. or more, the dielectric constant becomes excessively high, and the particle discharge starting voltage is remarkably reduced, thus significantly impairing the electric properties.

After study by the inventors of the present invention, it is found that reduction of the electrical properties in the high temperature environment is caused by a siloxane gas derived from the silicone rubber. The siloxane gas is an outgas generated in such a manner that siloxane of a low molecular weight (also referred to as simply siloxane component hereafter) contained in the silicone rubber is heated and evaporated when exposed to a high temperature environment, such as an environment of 160° C. or more for example. Although the reason for a rise of the dielectric constant in the high temperature environment due to the siloxane gas is not clear, the inventors of the present invention considers as follows. That is, it is conceivable that in the high temperature environment of 160° C. to 170° C., molecular vibration of the siloxane gas is likely to occur to thereby raise the dielectric constant of the insulated layer, or a molecular motion becomes active and the molecular motion of the peripheral PPS resin is stimulated, to thereby raise the dielectric constant of the insulated layer.

Accordingly, the inventors of the present invention study on a method of suppressing the generation of the siloxane gas from the silicone rubber. As a result, the inventors of the present invention consider it appropriate to apply annealing to the silicone rubber. According to the annealing, the siloxane gas is evaporated from the silicone rubber and a siloxane component of a low molecular weight which is a cause of the siloxane gas can be removed. After study by the inventors of the present invention, it is confirmed that the annealing is preferably applied by raising a temperature of the silicone rubber to 160° C. or more at which the siloxane gas starts to be evaporated, and the heating is continued until the mass loss caused by generation of the siloxane gas is saturated. The silicone rubber thus annealed has less content of the siloxane component, and a generation amount of the siloxane gas due to heating is small, and therefore the mass loss due to generation of the siloxane gas is less than 1% of the mass before heating.

According to such a silicone rubber, when the insulated layer is formed by mixing with the PPS resin, the generation of the siloxane gas in the high temperature environment can be suppressed, and therefore the dielectric constant of the insulated layer can be decreased, the partial discharge starting voltage of the insulated layer can be raised, and the electrical properties can be improved. In addition, the adhesion to the conductor of the insulated layer can be improved without significantly reducing the heat resistance of the insulated layer.

Therefore, according to the resin composition containing the silicon rubber with less generation amount of the siloxane gas, and the PPS resin, the insulated layer having excellent heat resistance, electrical properties, and adhesion to the conductor, can be formed.

Further, annealing may be applied to the silicone rubber alone before mixing it into the PPS resin, or may be applied to the resin composition prepared by mixing the silicone rubber into the PPS resin. Further, annealing may be applied after the resin composition is molded on the insulated layer by extruding the resin composition to coat the outer circumference of the conductor.

The present invention is provided based on the abovementioned knowledge.

### <Schematic Constitution of the Insulated Wire>

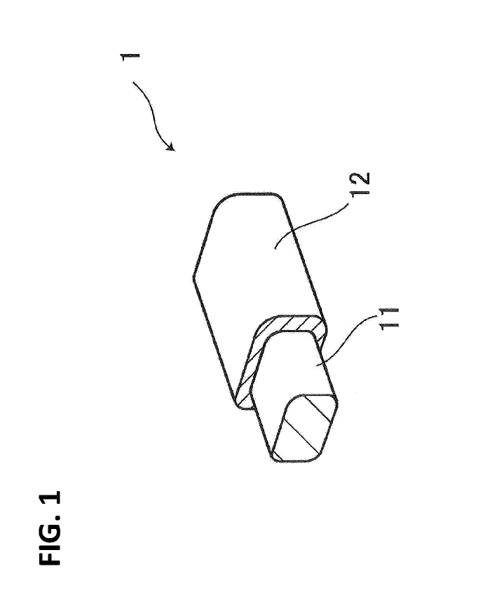

The insulated wire according to an embodiment of the present invention will be described hereafter, with reference to the drawings. FIG. 1 is a schematic view illustrating a constitution of the insulated wired according to an embodiment of the present invention.

### [Conductor 11]

As illustrated in FIG. 1, an insulated wire 1 includes a conductor 11. As the conductor 11, a metal wire made of a metal having a high conductivity, for example, a copper wire made of a low oxygen copper or oxygen-free copper, or aluminum wire can be used. FIG. 1 illustrates a case of a flat rectangular wire in which the conductor 11 has substantially a rectangular cross-section. However, the wire is not limited to the flat rectangular wire as the conductor 11, and a round wire having a circular cross-section can also be used. Further, as the conductor 11, it is also possible to use a stranded wire formed by twisting a plurality of round wires. In addition, metal plating such as tin or nickel, etc., may be applied on the surface of the conductor 11.

### [Insulated Layer 12]

An insulated layer 12 is provided on the outer circumference of the conductor 11 so as to coat the conductor 11. In this embodiment, since the insulated layer 12 is made of a prescribed resin composition, the insulated layer 12 is configured so that the mass loss caused by generation of the siloxane gas from the silicone rubber is less than 1% of the mass of the silicone rubber in a temperature state of 160° C. or more, namely, so that the generation amount of the siloxane gas is small. Therefore, the insulated layer 12 has excellent electrical properties even at a high temperature. Also, the insulated layer 12 contains the PPS resin, and therefore has excellent electrical properties. Further, the insulated layer 12 contains silicone rubber, and therefore has excellent adhesion to the conductor 11 and also has excellent heat resistance.

The insulated layer 12 has excellent electrical properties and its dielectric constant is 4 or less in a temperature range of 20° C. to 190° C. Further, when the partial discharge starting voltage of the insulated layer 12 at 20° C. is defined as V1, and the partial discharge starting voltage thereof at 190° C. is defined as V2, the ratio V2/V1 is 75% or more, and the insulated layer 12 can obtain a high partial discharge even at a high temperature as well, similarly to the case of a low temperature.

A thickness of the insulated layer 12 is not particularly limited. However, 0.05 mm or more and 0.4 mm or less is preferable, and 0.1 mm or more and 0.3 mm or less is more preferable, and 0.15 mm or more and 0.2 mm or less is further preferable.

### [Resin Composition for Forming the Insulated Layer 12]

Here, the resin composition for forming the insulated layer 12 will be specifically described.

The resin composition contains PPS resin and silicone rubber constituted so that the generation amount of the siloxane gas is small.

PPS resin includes a repeating unit, for example composed of p-phenylene sulfide, and is a polymer having excellent electrical properties, heat resistance, and mechanical properties, and also having excellent solvent resistance and oil resistance. From a viewpoint of the heat resistance of the insulated layer 12, PPS resin preferably contains 85% or more, and more preferably 90% or more of the repeating unit composed of p-phenylene sulfide.

From a viewpoint of obtaining desired high electrical properties in the insulated layer 12, crystallinity of the PPS resin is preferably 90% or more. By obtaining high crystallinity, various properties such as abrasion resistance, chemical resistance, and oil resistance, etc., of the insulated layer 12 can be improved, and the electrical properties can be improved accordingly. If the crystallinity of the PPS resin is 90% or more, there is a problem of impairing a bending property and an elongation property of the insulated layer 12, thus reducing the adhesion to the conductor 11. However, in this embodiment, by containing the silicone rubber together with PPS resin, it is possible to prevent the reduction of the adhesion and electrical properties.

The crystallinity is defined as follows in this embodiment. That is, crystallinity α is represented by the following formula (1), when crystallization heat during cold crystallization measured by differential scanning calorimetry is defined as Hc, and heat of fusion measured by differential scanning calorimetry is defined as Hm.

Crystallinityα=(1−Hc/Hm)×100 (1)

Silicone rubber is an elastomer component. In this embodiment, from a viewpoint of suppressing the reduction of the electrical properties due to siloxane gas, silicone rubber with small generation amount of the siloxane gas is used. Specifically, the silicon rubber is used so that the mass loss before and after heating is less than 1%, preferably 0.5% or less of the mass before heating, when the temperature is raised to 160° C. or more and heating is continued until the mass loss caused by generation of the siloxane gas is saturated. According to such a silicone rubber, adhesion between the insulated layer 12 and the conductor 11 can be improved by mixing with PPS resin without significantly reducing the electrical properties of the insulated layer 12. Further, the insulated layer 12 has excellent heat resistance among elastomer components, and therefore the heat resistance of the insulated layer 12 is not significantly reduced, which is a case in other elastomer component.

As the siloxane gas generated from silicone rubber, for example, dodecamethylcyclohexasiloxane, formic acid, 2-hydroxyethyl, tetradecapeptide methyl cycloheptadienyl siloxane, octa decamethylcyclopentasiloxane, nona siloxane, ethylene glycol formate, hexadecanol methyl cyclooctadiene siloxane, and eicosapentaenoic methyl tricyclodecanyl siloxane, etc., are used.

A mixture amount of the silicone rubber is not particularly limited. However, from a viewpoint of further improving the adhesion between the insulated layer 12 and the conductor 11, preferably a mixture amount of the silicone rubber is set to 2 mass % or more and 10 mass % or less, and a mixture amount of the PPS resin is set to 90 mass % or more and 98 mass % or less. Thus, it is possible to obtain not only the adhesion so as to pass a rapid elongation test described below, but also further high adhesion so as to pass an edgewise bending test described later.

Other additives other than the abovementioned PPS resin and silicone rubber may be mixed into the resin composition. As other additives, publicly-known additives such as antioxidants and colorants can be used. The mixture amount of them is not particularly limited, as long as it is in a range of not impairing the effect of the present invention.

### <Method of Manufacturing the Insulated Wire>

A method of manufacturing the abovementioned insulated wire will be described next. The method of manufacturing the insulated wire of this embodiment includes: a preparing step S10 of preparing a resin composition; a preheating step S20 of preheating a conductor 11; an extrusion coating step S30 of extruding the resin composition so as to coat an outer circumference of the conductor 11; and a cooling step S40 of cooling the resin composition to form an insulated layer 12.

### (Preparing Step S10)

First, the resin composition for forming the insulated layer 12 is prepared.

A preparing step S10 includes an annealing step S11 of applying annealing to the silicone rubber, and a mixing step S12 of mixing the annealed silicone rubber and PPS resin.

In the annealing step S11, the siloxane gas is evaporated and removed from the silicone rubber by applying annealing to the silicone rubber. Specifically, the temperature of the silicone rubber is raised to 160° C. or more, preferably 160° C. to 190° C., and thereafter heating is continued at a prescribed temperature for 1 hour to 3 hours for example until the mass loss caused by generation of the siloxane gas is saturated. Thus, the silicone rubber with less generation amount of the siloxane gas is obtained. The silicone rubber with initially less generation amount of a siloxane component may be used as the silicone rubber with less generation amount of siloxane gas.

In the mixing step S12, the silicone rubber obtained in the annealing step S11, PPS resin, and other additive such as an antioxidant, etc., are mixed as needed. By kneading the mixture at a prescribed shear rate while applying heating thereto, the resin composition for forming the insulated layer 12 is prepared. The heating temperature may be a temperature at which the PPS resin and the silicone rubber can be respectively melted. The kneading can be performed using a publicly-known kneading device such as a kneader, a Banbury mixer, a roll, and a twin-screw extruder, etc.

### (Preheating Step S20)

Subsequently, the conductor 11 (simply called a flat rectangular conductor 11 hereafter) having substantially a rectangular cross-section, is preheated before extrusion-coating of the resin composition onto the outer circumference. Thus, when the melted resin composition is extruded on the outer circumference of the flat rectangular conductor 11, the resin composition is prevented from being cooled by the flat rectangular conductor 11, and the adhesion of the formed insulated layer 12 can be increased. The temperature for heating the flat rectangular conductor 11 is preferably set to a temperature of a melting point or more of the resin composition, for example, a temperature of a melting point or more of the PPS resin.

When the flat rectangular conductor 11 is preheated, it is preferable to heat the flat rectangular conductor 11 in an inert gas atmosphere. Thus, oxidation of the flat rectangular conductor 11, and reduction in the adhesion of the insulated layer 12 due to formation of an oxide film can be suppressed. As the inert gas, for example, a nitride gas, etc., can be used.

### (Extrusion-Coating Step S30)

Subsequently, the heated flat rectangular conductor 11 is introduced to an extruder. Then, the resin composition is extruded by the extruder with a prescribed thickness to coat the outer circumference of the flat rectangular conductor 11.

### (Cooling Step S40)

Subsequently, the extruded resin composition is cooled to form the insulated layer 12. In the cooing step, in order to increase the crystallinity of the PPS resin contained in the insulated layer 12, preferably the melted resin composition (for example 300° C.) is rapidly cooled until the temperature reaches a melting point or less of the PPS resin and a crystallization temperature or more (for example, 180° C.) of the PPS resin, and thereafter is gradually cooled at a temperature in the vicinity of the crystallization temperature (for example, 180° C. to 100° C.). Accordingly, crystallization of the PPS resin can be encouraged, and the crystallinity of the PPS resin in the obtained insulated layer 12 can be increased to 90% or more for example.

Through the above-described steps, the insulated wire 1 having the insulated layer 12 formed on the outer circumference of the flat rectangular conductor 11 is manufactured.

In the above-described embodiment, explanation is given for a case in which annealing is applied to the silicone rubber alone and thereafter the silicon rubber is mixed into the PPS resin in the preparing step S10. However, the present invention is not limited thereto. For example, after the silicon rubber and the PPS resin is mixed to prepare the resin composition, annealing may be applied to the resin composition. Further, for example, it is also acceptable to mix the silicone rubber and the PPS resin to prepare the resin composition, which is then extruded to coat the outer circumference of the conductor so that the insulated layer is molded, and thereafter annealing may be applied thereto.

### EXAMPLE

The present invention will be described next in further detail, based on examples. However, the present invention is not limited to these examples.

### Preparation of the Resin Composition for Forming the Insulated Layer

### Example 1

First, annealing was applied to the silicone rubber for 2 hours at 190° C. and the siloxane gas is evaporated and removed from the silicone rubber, to thereby produce the silicone rubber so that the generation amount of the siloxane gas is less than 1% of the mass before heating.

Subsequently, as shown in the following table 1, 98 mass % of PPS resin (melting point: 280° C., viscosity: 230 Pas at a shear rate of 1000/s). and 2 mass % of the annealed silicone rubber are kneaded, to thereby prepare the resin composition of example 1.

TABLE 1

| | | | Example 1 | Example 2 | Example 3 | Example 4 | Com. Ex. 1 | Com. Ex. 2 | Com. Ex. 3 |
|---|---|---|---|---|---|---|---|---|---|
| Resin | Polyphenylene sulfide resin [mass %] | | 98 | 95 | 90 | 85 | 100 | 95 | 90 |
| composition | Silicone rubber | Annealed | 2 | 5 | 10 | 15 | — | — | — |
| | [mass %] | Not annealed | — | — | — | — | — | 5 | 10 |
| Insulated | Thickness [mm] | | 0.15 | 0.18 | 0.20 | 0.16 | 0.14 | 0.15 | 0.15 |
| layer | Outgas | | ○ | ○ | ○ | ○ | ○ | × | × |
| | Dielectric | 20° C. | 3.4 | 3.5 | 3.5 | 3.5 | 3.3 | 3.5 | 3.5 |
| | constant | 150° C. | 3.5 | 3.5 | 3.5 | 3.6 | 3.4 | 3.5 | 3.5 |
| | | 190° C. | 3.5 | 3.5 | 3.5 | 3.7 | 3.4 | 10 or more | 10 or more |
| | Partial discharge | 20° C. (V1) | 1850 | 2100 | 2150 | 1870 | 1770 | 1780 | 1810 |
| | starting voltage [v] | 150° C. | 1560 | 1840 | 1970 | 1580 | 1610 | 1600 | 1560 |
| | | 190° C. (V2) | 1480 | 1680 | 1710 | 1460 | 1450 | 840 | 790 |
| | Ratio V2/V1 | | 0.80 | 0.80 | 0.80 | 0.78 | 0.82 | 0.47 | 0.44 |
| | Adhesion to | Rapid elongation test | ○ | ○ | ○ | ○ | × | ○ | ○ |
| | conductor | Edgewise bending test | ○ | ○ | ○ | × | × | ○ | ○ |

| | | | | | | | |
|---|---|---|---|---|---|---|---|
| Heat resistance | ○ | ○ | ○ | ○ | ○ | ○ | ○ |

Com. Ex. = Comparative Example

### Examples 2 to 4

In examples 2 to 4, as shown in the abovementioned table 1, resin compositions of examples 2 to 4 were prepared similarly to example 1, other than a point that the resin composition was prepared by changing a mixture ratio of the PPS resin and the annealed silicone rubber.

### Comparative Example 1

In comparative example 1, the resin composition made of PPS resin was prepared without mixing the silicone rubber.

### Comparative Examples 2 and 3

In comparative examples 2 and 3, the resin composition was prepared without annealing, and similarly to example 1 other than a point that the silicone rubber with large generation amount of the siloxane gas was used so that the generation amount of the siloxane gas was 1% of the mass before heating. 5 mass % in comparative example 2 and 10 mass % in comparative example 3, of the silicone rubber without annealing was used.

### [Production of the Insulated Wire]

The insulated wire was prepared using the prepared resin composition.

Specifically, in a preheating device, the flat rectangular copper wire as a conductor was preheated to about 300° C. in the nitrogen atmosphere. Thereafter, the heated flat rectangular copper wire was introduced to the extruder, and an extrusion temperature was set to about 300° C., and the resin composition was extruded to coat the outer circumference of the flat rectangular copper wire, to thereby form the insulated layer with a prescribed thickness and produce the insulated wire. In this example, the flat rectangular copper wire with a long side of about 3 mm, a short side of about 2 mm, and a corner curvature radius of 0.3 mm, was used.

### [Evaluation Method]

The produced insulated wire was evaluated by the following method.

### (Method of Confirming the Outgas)

About 5 mg sample was collected from the insulated layer of the produced insulated wire, as a measurement object. The temperature of the sample was raised to 190° C. at a rate of 10° C. per minute by a thermogravimetric meter, and thereafter the sample was held for 1 hour at 190° C. When a reduction amount of a sample mass due to generation of the outgas was 1% or more of the mass of the silicone rubber, the component of the outgas was further analyzed by gas chromatography. As a result of the analysis, when the generation amount of the siloxane gas was less than 1 mass % of the mass of the silicone rubber, the analysis was judged as pass (∘), and when the generation amount of the siloxane gas exceeds 1 mass %, the analysis was judged as failure (x).

### (Dielectric Constant of the Insulated Layer)

The insulated layer was peeled-off from the insulated wire, and the insulated layer was pressed, or the resin composition was injection-molded, to thereby produce a sample sheet with a thickness of 1 mm. The sheet thus obtained was sandwiched between electrodes with a diameter of 50 mm, and held in a thermostatic bath at a room temperature (20° C.), 150° C. and 190° C. respectively, to thereby measure an electrostatic capacity at each temperature. Then, the dielectric constant of the sample at each temperature was calculated from the measured electrostatic capacity. In this example, when the dielectric constant is 4 or less at all temperatures, the calculation was judged as pass, and when the dielectric constant exceeds 4 at one of the temperatures, the calculation was judged as failure.

### (Partial Discharge Starting Voltage of the Insulated Layer)

Surfaces which are long sides of two insulated wire were brought into close contact with each other so as not to cause a gap over a length of 150 mm, to thereby produce a sample. The sample thus obtained was held in the thermostatic bath at a room temperature (20° C.), 150° C. and 190° C. respectively. Thereafter, an alternating current having a frequency of 50 Hz was applied between two conductors, and the voltage was boosted at 10V per second, to thereby measure the voltage at the time of 50 times or more occurrence of the partial discharge of 50 pC, as the partial discharge starting voltage. In this example, when the partial discharge starting voltage was 1450V or more at all temperatures, the measurement was judged as pass, and when the partial discharge starting voltage was less than 1450V, the measurement was judged as failure.

### (Rapid Elongation Test)

In order to evaluate the adhesion between the insulated layer and the conductor, a rapid elongation test was performed to the insulated wire. Specifically, both ends of the insulated wire were fixed by chucks respectively. At this time, the both ends were fixed so that a distance between the chucks was 25 cm. Then, one end of the insulated wire was pulled at a tensile rate of 1000 mm/min so that the insulated wire was rapidly elongated, to thereby cause a fracture in the insulated wire. Thereafter, at both ends of the fractured position of the insulated wire, a length of a coat lifting of the insulated layer and an exposure length of the conductor were measured, and when a total length of them was less than 7 mm, the test was judged as a high adhesion and pass (∘), and when the total length of them was 7 mm or more, the test was judged as an insufficient adhesion and failure (x).

### (Edgewise Bending Test)

In order to evaluate the adhesion of the insulated layer and the conductor, an edgewise bending test was performed to the insulated wire. Specifically, the insulated wire was elongated by 30%, and thereafter the edgewise bending test with a diameter of 2 mm and angle of 90° was performed. Then, when cracks or coat lifting was not generated on the insulated layer, the test was judged as a high adhesion and pass (∘), and when the cracks or coat lifting were generated, the test was judged as an insufficient adhesion and failure (x).

### (Heat Resistance)

The insulated wire was held in the thermostatic bath for 1000 hours at 190° C., and thereafter the insulated ware was taken out from the thermostatic bath, and a surface of the insulated layer was observed by a microscope. When there was no cracks found on the insulated layer, the insulated wire was judged as having excellent heat resistance and pass (∘), and when there was cracks generated on the insulated layer, the insulated wire was judged as having insufficient heat resistance and failure (x).

### [Evaluation Result]

An evaluation result is shown in the abovementioned table 1.

In all examples 1 to 4, it was confirmed that the heat resistance of the insulated layer was high. It was also confirmed that the dielectric constant of the insulated layer at 20° C. to 190° C. was 4 or less at all these temperatures, and the partial discharge starting voltage at 20° C. to 190° C. was 1450V or more at all these temperatures, and the insulated layer had excellent electric property. It was also confirmed that the ratio of the partial discharge starting voltage V2 at 190° C. and the partial discharge starting voltage V1 at 20° C. was 75% or more, and a high partial discharge starting voltage could be obtained even at a high temperature. It was also confirmed that high adhesion could be obtained in all examples 1 to 4 so as to pass the rapid elongation test. Especially, in examples 1 to 3, 90 mass % to 98 mass % of the PPS resin, and 2 mass % to 10 mass % of the silicone rubber were mixed, and therefore it was confirmed that high adhesion was obtained so as to pass not only the rapid elongation test, but also the edgewise bending test.

In comparative example 1, the insulated layer was formed only by the PPS resin without mixing the silicone rubber, and therefore it was confirmed that the adhesion of the insulated layer was significantly reduced by increasing the crystallinity of the PPS resin.

In comparative examples 2 and 3, the generation amount of the siloxane gas was high, which was generated when the insulated layer was exposed to a high temperature, and therefore it was confirmed that the dielectric constant at 200° C. was 10 or more and high, and the partial discharge starting voltage was less than 1450V, and the electric property was low.

### <Preferable Aspects of the Present Invention>

Preferable aspects of the present invention will be supplementarily described hereafter.

### [Supplementary Description 1]

According to an aspect of the present invention, there is provided an insulated wire, including:

a conductor; and

an insulated layer arranged on an outer circumference of the conductor,

wherein the insulate layer is made of a resin composition including polyphenylene sulfide resin and silicone rubber, and in a state of 160° C., a mass loss of the insulated layer which is caused by generation of a siloxane gas from the silicone rubber, is less than 1% of the mass of the silicone rubber.

### [Supplementary Description 2]

In the insulated wire of the supplementary description 1, preferably, the resin composition contains 90 mass % or more and 98 mass % or less of the polyphenylene sulfide resin, and 2 mass % or more and 10 mass % or less of the silicone rubber.

### [Supplementary Description 3]

In the insulated wire of the supplementary description 1 or 2, preferably annealing is applied to the silicone rubber.

### [Supplementary Description 4]

In the insulated wire of the supplementary descriptions 1 to 3, preferably, regarding the polyphenylene sulfide resin, crystallinity α represented by the following formula (1) is 90% or more, when crystallization heat during cold crystallization measured by differential scanning calorimetry is defined as Hc, and heat of fusion measured by differential scanning calorimetry is defined as Hm.

Crystallinityα=(1−Hc/Hm)×100 (1)

### [Supplementary Description 5]

In the insulated wire of the supplementary descriptions 1 to 4, preferably, a dielectric constant of the insulated layer is 4 or less in a temperature range of 20° C. to 190° C.

### [Supplementary Description 6]

In the insulated wire of the supplementary descriptions 1 to 5, preferably, when a partial discharge starting voltage of the insulated layer at 20° C. is defined as V1, and a partial discharge starting voltage of the insulated layer at 190° C. is defined as V2, the ratio V2/V1 is 75% or more.

### [Supplementary Description 7]

According to another aspect of the present invention, there is provided an insulated wire, including:

a conductor; and

an insulated layer arranged on an outer circumference of the conductor,

wherein the insulate layer is made of a resin composition including polyphenylene sulfide resin and silicone rubber, and

a mass loss of the insulated layer before and after heating is less than 1% of the mass of the silicone rubber, when a temperature of the insulated layer is raised to 160° C. or more and heating is continued until the mass loss which is caused by generation of a siloxane gas derived from the silicone rubber is saturated.

### [Supplementary Description 8]

According to further another aspect of the present invention, there is provided a method of manufacturing an insulated wire, including:

annealing a silicone rubber by raising a temperature of the silicon rubber to 160° C. or more and continuing the heating until a mass loss before and after heating the silicone rubber, which is caused by generation of a siloxane gas, is less than 1% of the mass of the silicone rubber before heating;

preparing a resin composition by mixing the annealed silicone rubber and polyphenylene sulfide resin;

heating and melting the resin composition and extruding it so as to coat an outer circumference of a conductor; and

cooling the extruded resin composition to form an insulated layer.

### [Supplementary Description 9]

The method of manufacturing an insulated wire of the supplementary description 8, preferably, includes:

preheating the conductor before extruding the resin composition,

wherein in the extruding and coating, the resin composition is extruded on an outer circumference of the preheated conductor.

### [Supplementary Description 10]

In the method of manufacturing an insulated wire of the supplementary description 8 or 8, preferably, in the cooling, a temperature of the resin composition is maintained in a range of a crystallization temperature or more and a melting point or less of the polyphenylene sulfide resin, and the resin composition is cooled so that crystallinity α represented by the following formula (1) is 90% or more, when crystallization heat during cold crystallization measured by differential scanning calorimetry is defined as Hc, and heat of fusion measured by differential scanning calorimetry is defined as Hm.

Crystallinityα=(1−Hc/Hm)×100 (1)

### [Supplementary Description 11]

According to further another aspect of the present invention, there is provided a method of manufacturing an insulated wire, including:

preparing a resin composition by mixing silicone rubber and polyphenylene sulfide resin, to prepare a resin composition;

annealing the silicone rubber by raising a temperature of the silicon rubber to 160° C. or more and continuing the heating until a mass loss before and after heating the resin composition, which is caused by generation of a siloxane gas derived from the silicone rubber, is less than 1% of the mass of the silicone rubber before heating;

heating and melting the annealed resin composition to coat an outer circumference of a conductor; and

cooling the extruded resin composition to form an insulated layer.

### [Supplementary Description 12]

According to further another aspect of the present invention, there is provided a method of manufacturing an insulated wire, including:

mixing silicone rubber and polyphenylene sulfide resin, to prepare a resin composition;

heating and melting the resin composition and extruding it so as to coat an outer circumference of a conductor;

cooling the extruded resin composition to form an insulated layer, and

annealing a silicone rubber by raising a temperature of the silicon rubber to 160° C. or more and continuing the heating until a mass loss of the silicone rubber before and after heating, which is caused by generation of a siloxane gas, is less than 1% of the mass of the silicone rubber before heating.

What is claimed is:

1. An insulated wire, comprising:
a conductor; and
an insulated layer arranged on an outer circumference of the conductor,
wherein the insulate layer is made of a resin composition including polyphenylene sulfide resin and silicone rubber, and in a state of 160° C. or more, a mass loss of the insulated layer which is caused by generation of a siloxane gas from the silicone rubber, is less than 1% of the mass of the silicone rubber.

2. The insulated wire according to claim 1, wherein the resin composition contains 90 mass % or more and 98 mass % or less of the polyphenylene sulfide resin, and 2 mass % or more and 10 mass % or less of the silicone rubber.

3. The insulated wire according to claim 1, wherein annealing is applied to the silicone rubber.

4. The insulated wire according to claim 1, wherein regarding the polyphenylene sulfide resin, crystallinity α represented by the following formula (1) is 90% or more, when crystallization heat during cold crystallization measured by differential scanning calorimetry is defined as Hc, and heat of fusion measured by differential scanning calorimetry is defined as Hm.
Crystallinityα=(1−Hc/Hm)×100 (1)

5. The insulated wire according to claim 1, wherein a dielectric constant of the insulated layer is 4 or less in a temperature range of 20° C. to 190° C.

6. The insulated wire according to claim 1, wherein when a partial discharge starting voltage of the insulated layer at 20° C. is defined as V1, and a partial discharge starting voltage of the insulated layer at 190° C. is defined as V2, the ratio V2/V1 is 75% or more.

7. An insulated wire, comprising:
a conductor; and
an insulated layer arranged on an outer circumference of the conductor,
wherein the insulate layer is made of a resin composition including polyphenylene sulfide resin and silicone rubber, and
a mass loss of the insulated layer before and after heating is less than 1% of the mass of the silicone rubber, when a temperature of the insulated layer is raised to 160° C. or more and heating is continued until the mass loss which is caused by generation of a siloxane gas derived from the silicone rubber is saturated.

8. A method of manufacturing an insulated wire, comprising:
annealing a silicone rubber by raising a temperature of the silicon rubber to 160° C. or more and continuing the heating until a mass loss before and after heating the silicone rubber, which is caused by generation of a siloxane gas, is less than 1% of the mass of the silicone rubber before heating;
preparing a resin composition by mixing the annealed silicone rubber and polyphenylene sulfide resin;
heating and melting the resin composition and extruding it so as to coat an outer circumference of a conductor; and
cooling the extruded resin composition to form an insulated layer.

9. The method of manufacturing an insulated wire according to claim 8, comprising:
preheating the conductor before extruding the resin composition,
wherein in the extruding and coating, the resin composition is extruded on an outer circumference of the preheated conductor.

10. The method of manufacturing an insulated wire according to claim 8, wherein in the cooling, a temperature of the resin composition is maintained in a range of a crystallization temperature or more and a melting point or less of the polyphenylene sulfide resin, and the resin composition is cooled so that crystallinity α represented by the following formula (1) is 90% or more, when crystallization heat during cold crystallization measured by differential scanning calorimetry is defined as Hc, and heat of fusion measured by differential scanning calorimetry is defined as Hm.
Crystallinityα=(1−Hc/Hm)×100 (1)
